(19) United States
(12) Patent Application Publication
(10) Pub. No.: US 2007/0259069 A1
(43) Pub. Date: Nov. 8, 2007

(54) Gel-Tek

(76) Inventor: Ralph Van Blarcom, Land O Lakes, FL (US)

Correspondence Address: RALPH VAN BLARCOM;TA AQUARIUM PRODUCTS, INC., 180 - H Penrod CT., Glen Burnie, MD, 21061, US

(21) Appl. No.: 11/418,162

(22) Filed: May 5, 2006

(51) Int. Cl. A23K 1/18

(52) U.S. Cl. 426/2

(57) ABSTRACT

Gel Tek's formulation consists of an aqueous gel of 0.157% Carbopol Polymer, a hydrophobically modified crosslinked polyacrylate polymer. Along with 0.050% fish pheromones to induce feeding behavior and attractants, in the form of 0.060% Pimpinella anisum and 0.030 Fish oil. Contains 0.120% preservatives. Coloring 0.030% is used as well to attract fish.

### BACKGROUND

Medicating fish has always been a major problem when it came to internal disease issue. Treatments have always been applied to the water where the fish reside in hopes that the medication would absorb into the fishes body and treat the disease problem.

Attempts to apply medications to fish feed have had varying results and only a few medicates have been offered.

Research studies conducted at the University of Georgia, College of Veterinary Medicine, have demonstrated that very little if any of the antibiotics and chemicals tested absorbed into the tissue of the fish when treated in the water where the fish reside.

Other problems resulted from treating the water where the fish reside included damage to the biological filtering system. This creates environmental toxins, which can damage or kill the fish.

Gel-Tek was invented to eliminate these issues and provide an effective method of medicating sick fish.

### SUMMARY

Gel-Tek's formula can be mixed with various components as mentioned in the Specifications. Once mixed with a component, the Gel-Tek is administered to the aquarium drop wise forming small pea sized floating gel bodies which are neutrally buoyant, which is essential to allowing the fish to eat it providing a treatment that is taken internally and will not affect the aquarium equilibrium. The uneaten Gel Tek dissolves in a short period of time leaving no residue.

Present Products with Gel Tek:

Gel-Tek Ultra Cure BX . . . Nitrofurazone, Triple Sulfa

Gel-Tek Ultra Cure PX . . . Praziquantel, Flubenol, Metronidazole

Gel-Tek Ultra Ultra Color FX . . . Haematococcus

Gel-Tek Ultra Gro VX . . . Spirulina pacifica

Gel-Tek TC . . . Tetracycline

Gel-Tek AMP . . . Ampicillin

Gel-Tek Pen . . . Penicillin

Gel-Tek EM . . . Erythromycin

Gel-Tek-NEO . . . Neomycin

Gel-Tek Ultra Ich. Gel

### DESCRIPTION

Gel Tek is a mechanism in the form of a hydrolytic gel with feeding inducements, to carry antibiotics, chemicals, anthelmintics, to include parasitic copepods, flukes, monogenetic, digenetic trematodes, protozoan, fungal and sporazoan treatments as well as dietary supplements to include algae, mineral, electrolyte and vitamin additives to captive tropical fish for consumption.

Gel-Tek is used as a carrier for treatments; medication, metabolic stability and not limited to diseases of freshwater or marine captive tropical fish.

1. Gel-Tek's formula can be mixed with various components as mentioned in the Specifications. Once mixed with a component, the Gel-Tek is administered to the aquarium drop wise forming small pea sized floating gel bodies which are neutrally buoyant, which is essential to allowing the fish to eat it providing a treatment that is taken internally and will not affect the aquarium equilibrium. The uneaten Gel-Tek dissolves in a short period of time leaving no residue.
Gel-Tek doe no, damage biological filtration.
Gel-Tek doe not stain or discolor aquarium sealant or decorations.
Gel-Tek's application mechanics does not allow antibiotic or other human or veterinary medications to be taken based on the normally mg/liter dosages required in there respected fields of medicine, thusly conforming to the Minor Animal Species Act to prevent misuse of aquatic remedies, signed in 2005.
